(19) United States
(12) Patent Application Publication
(10) Pub. No.: US 2024/0332587 A1
(43) Pub. Date: Oct. 3, 2024

(54) POWER GENERATION CELL AND FUEL CELL STACK

(71) Applicant: HONDA MOTOR CO., LTD., TOKYO (JP)

(72) Inventors: Fumiya ARAI, WAKO-SHI (JP); Yukihito TANAKA, WAKO-SHI (JP); Satoshi OYAMA, WAKO-SHI (JP); Keisuke ANDO, WAKO-SHI (JP); Yutaka EBATO, WAKO-SHI (JP); Natsumi IIZUKA, WAKO-SHI (JP); Takuro OKUBO, WAKO-SHI (JP)

(21) Appl. No.: 18/588,563

(22) Filed: Feb. 27, 2024

(30) Foreign Application Priority Data
Mar. 30, 2023 (CN) 202310332095.6

(51) Int. Cl. H01M 8/242; H01M 8/0206; H01M 8/0258; H01M 8/0273; H01M 8/0282; H01M 8/0284

(52) U.S. Cl. CPC H01M 8/242; H01M 8/0206; H01M 8/0258; H01M 8/0273; H01M 8/0282; H01M 8/0284

(57) ABSTRACT

In power generation cells of a fuel cell stack, a first sealing portion of a first metal separator is an elastically deformable metal sealing portion protruding from the first metal separator in a direction away from a membrane electrode assembly, a second sealing portion of a second metal separator is an elastically deformable resin seal member attached to a surface of the second metal separator that is opposite to a surface facing the membrane electrode assembly, and the resin seal member is in contact with the metal sealing portion.

### CROSS-REFERENCE TO RELATED APPLICATIONS

This application is based upon and claims the benefit of priority from Chinese Patent Application No. 202310332095.6 filed on Mar. 30, 2023, the contents of which are incorporated herein by reference.

### BACKGROUND OF THE INVENTION

### Field of the Invention

The present invention relates to a power generation cell and a fuel cell stack.

### Description of the Related Art

In recent years, research and development have been conducted on fuel cell stacks that contribute to energy efficiency in order to ensure that more people have access to affordable, reliable, sustainable and modern energy.

For example, JP 2018-125288 A discloses a fuel cell stack formed by stacking a plurality of power generation cells. Each of the power generation cells includes a membrane electrode assembly and a pair of metal separators disposed on both sides of the membrane electrode assembly. Each of the metal separators is provided with a seal for preventing leakage of a fluid that is an oxygen-containing gas, a fuel gas, or a coolant.

### SUMMARY OF THE INVENTION

There is a demand for a power generation cell and a fuel cell stack having a seal portion capable of effectively preventing fluid leakage while suppressing material cost.

An object of the present invention is to provide such a power generation cell and a fuel cell stack.

According to one aspect of the present invention, a power generation cell includes a membrane electrode assembly having an electrolyte membrane, and a cathode and an anode disposed on both sides of the electrolyte membrane, and a first metal separator and a second metal separator disposed on both sides of the membrane electrode assembly, each of the first metal separator and the second metal separator including a flow path through which a fluid flows, the fluid being one of an oxygen-containing gas, a fuel gas or a coolant, wherein each of the first metal separator and the second metal separator includes a sealing portion for preventing leakage of the fluid from a boundary between the first metal separator and the second metal separator in a case where the power generation cell is provided in plural and the plurality of power generation cells are stacked in a manner that the first metal separator and the second metal separator are positioned adjacent to each other, the sealing portion of the first metal separator is an elastically deformable metal sealing portion protruding from the first metal separator in a direction away from the membrane electrode assembly, the sealing portion of the second metal separator is an elastically deformable resin seal member attached to a surface of the second metal separator that is opposite to a surface facing the membrane electrode assembly, and the resin seal member is in contact with the metal sealing portion in a state where the plurality of power generation cells are stacked one another.

Another aspect of the present invention is a fuel cell stack in which a plurality of power generation cells as described above are stacked.

According to the present invention, it is possible to effectively prevent fluid leakage while suppressing material cost.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view showing a fuel cell stack according to one embodiment of the present invention;

FIG. 2 is an exploded perspective view of the power generation cell;

FIG. 3 is a cross-sectional view taken along line III-III of FIG. 2;

FIG. 4 is a plan view of a first metal separator;

FIG. 5 is a plan view of a second metal separator;

FIG. 6 is a cross-sectional view taken along line VI-VI of FIG. 2;

FIG. 7 is a cross-sectional view taken along line VII-VII of FIG. 2;

FIG. 8 is a partially omitted cross-sectional view of the power generation cell before being stacked; and

FIG. 9 is a cross-sectional view of a power generation cell according to another embodiment of the present invention.

### DETAILED DESCRIPTION OF THE INVENTION

A power generation cell 10 and a fuel cell stack 12 according to an embodiment of the present invention will be described below with reference to the drawings. The fuel cell stack 12 according to the present embodiment is mounted on, for example, a vehicle (not shown). The use of the fuel cell stack 12 is not particularly limited.

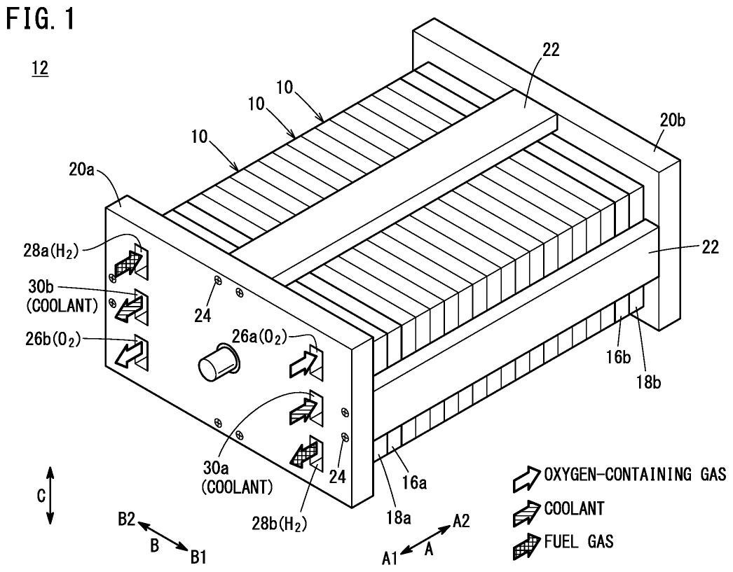

As shown in FIG. 1, the fuel cell stack 12 includes a plurality of power generation cells 10, a pair of terminal plates 16a, 16b, a pair of insulating plates 18a, 18b, and a pair of end plates 20a, 20b. The plurality of power generation cells 10 are stacked in the arrow A direction.

The terminal plate 16a is arranged adjacent to the power generation cell 10 positioned at one end (end on the arrow A1 side) in the stacking direction of the plurality of power generation cells 10. Arranged adjacent to the terminal plate 16a is the insulating plate 18a. Arranged adjacent to the insulating plate 18a is the end plate 20a. The insulating plate 18a is positioned between the terminal plate 16a and the end plate 20a.

The terminal plate 16b is arranged adjacent to the power generation cell 10 positioned at the other end (end on the arrow A2 side) in the stacking direction of the plurality of power generation cells 10. Arranged adjacent to the terminal plate 16b is the insulating plate 18b. Arranged adjacent to the insulating plate 18b is the end plate 20b. The insulating plate 18b is positioned between the terminal plate 16b and the end plate 20b.

Each of the end plates 20a, 20b has a horizontally long rectangular shape. The pair of end plates 20a, 20b are connected to each other by a plurality of coupling bars 22. One end surface of each of the coupling bars 22 is fastened to the inner surface of the end plate 20a by a bolt 24. The other end surface of each of the coupling bars 22 is fastened to the inner surface of the end plate 20b by a bolt (not shown). As a result, a compressive load (tightening load) in the stacking direction (the arrow A direction) is applied to the plurality of power generation cells 10. The fuel cell stack 12 may have a casing formed using the end plates 20a, 20b. In this case, a plurality of power generation cells 10 are housed in the casing.

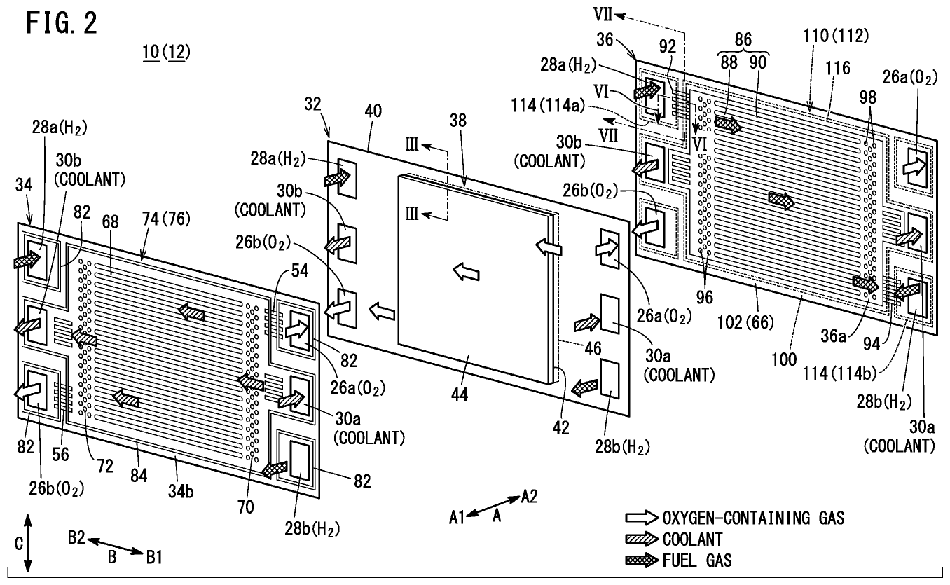

As shown in FIG. 2, the power generation cell 10 has a laterally elongated rectangular shape. The shape of the power generation cell 10 is not particularly limited, and may be formed in a vertically elongated rectangular shape or a square shape, for example. The power generation cell 10 generates power by electrochemical reactions between an oxygen-containing gas as one of the reactant gases and a fuel gas as the other of the reactant gases. The fuel gas is, for example, a hydrogen-containing gas. A coolant for cooling the power generation cell 10 flows through the power generation cell 10. The coolant is, for example, pure water, ethylene glycol, oil, or the like.

An oxygen-containing gas supply passage 26a, an oxygen-containing gas discharge passage 26b, a fuel gas supply passage 28a, a fuel gas discharge passage 28b, a coolant supply passage 30a and a coolant discharge passage 30b are formed to extend through each of the power generation cells 10 in the stacking direction (the arrow A direction).

One end of the longer side (one end on the arrow B1 side) of the power generation cell 10 is provided with the oxygen-containing gas supply passage 26a, the coolant supply passage 30a and the fuel gas discharge passage 28b. The oxygen-containing gas supply passage 26a, the coolant supply passage 30a, and the fuel gas discharge passage 28b are arranged along the shorter side of the power generation cell 10 (the arrow C direction).

The oxygen-containing gas flows through the oxygen-containing gas supply passage 26a in the direction indicated by the arrow A2. The coolant flows through the coolant supply passage 30a in the direction indicated by the arrow A2. The fuel gas flows through the fuel gas discharge passage 28b in the direction indicated by the arrow A1.

The other end of the longer side (the other end on the arrow B2 side) of the power generation cell 10 is provided with the fuel gas supply passage 28a, the coolant discharge passage 30b, and the oxygen-containing gas discharge passage 26b. The fuel gas supply passage 28a, the coolant discharge passage 30b, and the oxygen-containing gas discharge passage 26b are arranged in the arrow C direction.

The fuel gas flows through the fuel gas supply passage 28a in the direction indicated by the arrow A2. The coolant flows through the coolant discharge passage 30b in the direction indicated by the arrow A1. The oxygen-containing gas flows through the oxygen-containing gas discharge passage 26b in the direction indicated by the arrow A1.

As shown in FIG. 1, the oxygen-containing gas supply passage 26a, the oxygen-containing gas discharge passage 26b, the fuel gas supply passage 28a, the fuel gas discharge passage 28b, the coolant supply passage 30a, and the coolant discharge passage 30b are formed also in the one end plate 20a. The positions, shapes, and sizes of the oxygen-containing gas supply passage 26a, the oxygen-containing gas discharge passage 26b, the fuel gas supply passage 28a, the fuel gas discharge passage 28b, the coolant supply passage 30a, and the coolant discharge passage 30b may be set appropriately depending on required specifications.

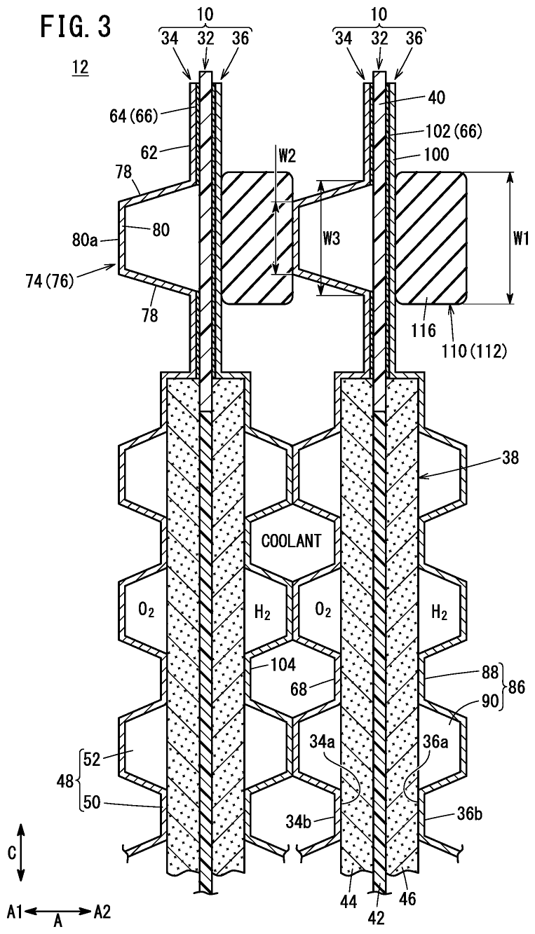

As shown in FIGS. 2 and 3, the power generation cell 10 includes a resin-framed membrane electrode assembly 32, a first metal separator 34, and a second metal separator 36. The first metal separator 34 is disposed on one surface (surface on the arrow A1 side) of the resin-framed membrane electrode assembly 32. The metal second separator 36 is disposed on the other surface (surface on the arrow A2 side) of the resin-framed membrane electrode assembly 32. The first metal separator 34 and the second metal separator 36 sandwich the resin-framed membrane electrode assembly 32 in the arrow A direction. In a state where the plurality of power generation cells 10 are stacked one another, the first metal separator 34 is in contact with the adjacent second metal separator 36 (see FIG. 3).

The resin-framed membrane electrode assembly 32 includes a membrane electrode assembly (MEA) 38 and a resin frame member 40. The membrane electrode assembly 38 includes an electrolyte membrane 42, a first electrode 44, and a second electrode 46. The electrolyte membrane 42 is, for example, a solid polymer electrolyte membrane (cation exchange membrane). The solid polymer electrolyte membrane is formed by impregnating a thin membrane of perfluorosulfonic acid with water, for example. As the electrolyte membrane 42, an HC (hydrocarbon)-based electrolyte can be used in addition to the fluorine-based electrolyte. The electrolyte membrane 42 is sandwiched between the first electrode 44 and the second electrode 46.

The first electrode 44 provided on one surface (surface on the arrow A1 side) of the electrolyte membrane 42 is a cathode. The second electrode 46 provided on the other surface (surface on the arrow A2 side) of the electrolyte membrane 42 is an anode. The first metal separator 34 is disposed so as to face the first electrode 44. The second metal separator 36 is disposed so as to face the second electrode 46.

As shown in FIG. 2, the oxygen-containing gas flowing through the oxygen-containing gas supply passage 26a is guided to flow between the first metal separator 34 and the resin-framed membrane electrode assembly 32, and is supplied to the first electrode 44. The fuel gas flowing through the fuel gas supply passage 28a is guided to flow between the second metal separator 36 and the resin-framed membrane electrode assembly 32, and is supplied to the second electrode 46. The power generation cell 10 generates power by the oxygen-containing gas supplied to the first electrode 44 and the fuel gas supplied to the second electrode 46.

The oxygen-containing gas flowing between the first metal separator 34 and the resin-framed membrane electrode assembly 32 is guided to the oxygen-containing gas discharge passage 26b. The fuel gas flowing between the second metal separator 36 and the resin-framed membrane electrode assembly 32 is guided to the fuel gas discharge passage 28b. The coolant supplied to the coolant supply passage 30a flows between the first metal separator 34 and the adjacent second metal separator 36, and then flows through the coolant discharge passage 30b.

As shown in FIGS. 2 and 3, the first electrode 44 includes a first electrode catalyst layer and a first gas diffusion layer. The first electrode catalyst layer is bonded to one surface of the electrolyte membrane 42. The first gas diffusion layer is laminated on the first electrode catalyst layer. The second electrode 46 includes a second electrode catalyst layer and a second gas diffusion layer. The second electrode catalyst layer is bonded to the other surface of the electrolyte membrane 42. The second gas diffusion layer is laminated on the second electrode catalyst layer. Each of the first gas diffusion layer and the second gas diffusion layer comprises a carbon paper, a carbon cloth, etc.

The resin frame member 40 is a frame-shaped sheet surrounding the outer periphery of the membrane electrode assembly 38. The inner peripheral end of the resin frame member 40 is sandwiched by the outer peripheral portion of the membrane electrode assembly 38 (see FIG. 3). The resin frame member 40 is an electrically insulating member.

Examples of materials of the resin frame member 40 include PPS (polyphenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified polyphenylene ether) resin, PET (polyethylene terephthalate), PBT (polybutylene terephthalate), and modified polyolefin.

As shown in FIG. 2, one end of the resin frame member 40 (one end on the arrow B1 side) is provided with the oxygen-containing gas supply passage 26a, the coolant supply passage 30a and the fuel gas discharge passage 28b. The other end of the resin frame member 40 (the other end on the arrow B2 side) is provided with the fuel gas supply passage 28a, the coolant discharge passage 30b, and the oxygen-containing gas discharge passage 26b.

The resin frame member 40 of the resin-framed membrane electrode assembly 32 may be formed by projecting the electrolyte membrane 42 outward from the outer peripheries of the first electrode 44 and the second electrode 46.

The first metal separator 34 is formed in a plate shape. The first metal separator 34 is, for example, a thin metal plate such as a steel plate, a stainless steel plate, or an aluminum plate. The first metal separator 34 may be subjected to an anti-corrosion treatment. The first metal separator 34 is formed in a rectangular shape. One end of the first metal separator 34 (one end of the arrow B1 side) is provided with the oxygen-containing gas supply passage 26a, the coolant supply passage 30a, and the fuel gas discharge passage 28b. The other end of the first metal separator 34 (the other end of the arrow B2 side) is provided with the fuel gas supply passage 28a, the coolant discharge passage 30b, and the oxygen-containing gas discharge passage 26b. The first metal separator 34 is formed by pressing a metal plate.

As shown in FIGS. 2 and 3, the first metal separator 34 has a first front surface 34a facing the resin-framed membrane electrode assembly 32, and a first back surface 34b facing the second metal separator 36 of the power generation cell 10 adjacent to the first metal separator 34.

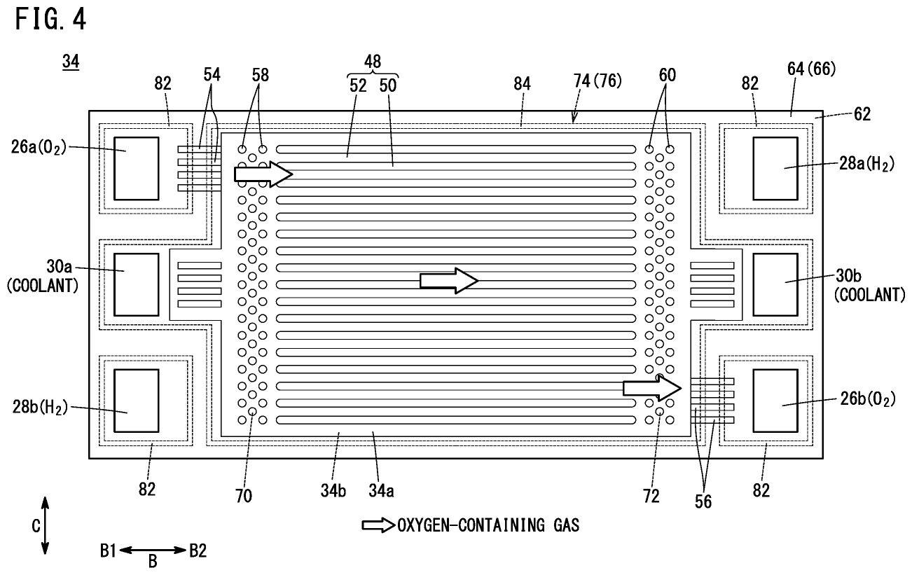

As shown in FIGS. 3 and 4, a first gas flow field 48 is formed on the first front surface 34a of the first metal separator 34. The first gas flow field 48 is an oxygen-containing gas flow field for allowing the oxygen-containing gas to flow along the first electrode 44. The first gas flow field 48 includes a plurality of first flow field ridges 50 and a plurality of first flow field grooves 52. The first flow field ridges 50 and the first flow field grooves 52 are alternately provided in the arrow C direction. Each of the first flow field ridges 50 and the first flow field grooves 52 extends linearly in the arrow B direction. Each of the first flow field ridges 50 and the first flow field grooves 52 may extend in a wave form in the arrow B direction.

As shown in FIG. 4, the first gas flow field 48 is connected to the oxygen-containing gas supply passage 26a through a plurality of first supply tunnels 54. The plurality of first supply tunnels 54 are arranged at intervals in the arrow C direction. The first supply tunnels 54 extend in the arrow B direction. The first supply tunnels 54 bulge from the first front surface 34a toward the first back surface 34b of the first metal separator 34. The oxygen-containing gas can flow through the first supply tunnels 54.

The first gas flow field 48 is connected to the oxygen-containing gas discharge passage 26b through a plurality of first discharge tunnels 56. The plurality of first discharge tunnels 56 are arranged at intervals in the arrow C direction. The first discharge tunnels 56 extend in the arrow B direction. The first discharge tunnels 56 bulge from the first front surface 34a toward the first back surface 34b of the first metal separator 34. The oxygen-containing gas can flow through the first discharge tunnels 56.

An inlet buffer 58 is provided between the first supply tunnels 54 and the first gas flow field 48. An outlet buffer 60 is provided between the first discharge tunnels 56 and the first gas flow field 48.

As shown in FIG. 3, the first metal separator 34 has a first joining section 62 to which the resin frame member 40 is joined. The resin frame member 40 is joined to the first joining section 62 via a first adhesive layer 64. The first adhesive layer 64 is formed of an adhesive 66 that blocks the flows of the oxygen-containing gas, the fuel gas, and the coolant.

The first adhesive layer 64 is formed, for example, by applying the adhesive 66 in the liquid form to the first front surface 34a of the first metal separator 34. The first adhesive layer 64 may be formed by applying the adhesive 66 in the liquid form to one surface (surface facing the first metal separator 34) of the resin frame member 40. The first adhesive layer 64 may be formed by sandwiching an adhesive sheet of a predetermined shape made of the adhesive 66 between the first metal separator 34 and the resin frame member 40.

As shown in FIG. 4, the first adhesive layer 64 surrounds the oxygen-containing gas supply passage 26a, the oxygen-containing gas discharge passage 26b, the fuel gas supply passage 28a, the fuel gas discharge passage 28b, the coolant supply passage 30a, and the coolant discharge passage 30b, individually. The first adhesive layer 64 surrounds the first gas flow field 48.

As shown in FIG. 2, a first coolant flow field 68 is formed on the first back surface 34b of the first metal separator 34. The first coolant flow field 68 has a shape of a back surface of the first gas flow field 48. An inlet buffer 70 is provided between the first coolant flow field 68 and the coolant supply passage 30a. An outlet buffer 72 is provided between the first coolant flow field 68 and the coolant discharge passage 30b.

The first back surface 34b of the first metal separator 34 is provided with a first sealing portion (seal) 74 for preventing leakage of a fluid that is the oxygen-containing gas, the fuel gas, or the coolant, to the outside. The first sealing portion 74 extends in a shape like a line. As shown in FIG. 3, the first sealing portion 74 is an elastically deformable metal sealing portion 76 that protrudes from the first metal separator 34 away (in the direction indicated by the arrow A1) from the membrane electrode assembly 38.

The metal sealing portion 76 is formed integrally with the first metal separator 34 by press forming the metal plate. The metal sealing portion 76 includes a pair of side walls 78 and a top portion 80. The pair of side walls 78 are disposed so as to face each other. The distance between the pair of side walls 78 narrows as the metal sealing portion 76 protrudes. The top portion 80 connects distal ends of the pair of side walls 78 to each other.

As shown in FIG. 2, the metal sealing portion 76 includes a plurality of first passage sealing portions 82 and a first flow path sealing portion 84. The plurality of first passage sealing portions 82 individually surround the oxygen-containing gas supply passage 26a, the oxygen-containing gas discharge passage 26b, the fuel gas supply passage 28a, and the fuel gas discharge passage 28b. The first flow path sealing portion 84 surrounds the coolant supply passage 30a, the first coolant flow field 68, and the coolant discharge passage 30b.

The second metal separator 36 is formed in a plate shape. The second metal separator 36 is, for example, a thin metal plate such as a steel plate, a stainless steel plate, or an aluminum plate. The second metal separator 36 may be subjected to an anti-corrosion treatment. The second metal separator 36 is formed in a rectangular shape. One end of the second metal separator 36 (one end of the arrow B1 side) is provided with the oxygen-containing gas supply passage 26a, the coolant supply passage 30a, and the fuel gas discharge passage 28b. The other end of the second metal separator 36 (the other end of the arrow B2 side) is provided with the fuel gas supply passage 28a, the coolant discharge passage 30b, and the oxygen-containing gas discharge passage 26b. The second metal separator 36 is formed by pressing a metal plate.

As shown in FIGS. 2 and 3, the second metal separator 36 has a second front surface 36a facing the resin-framed membrane electrode assembly 32, and a second back surface 36b facing the first metal separator 34 of the power generation cell 10 adjacent to the second metal separator 36.

A second gas flow field 86 is formed on the second front surface 36a of the second metal separator 36. The second gas flow field 86 is a fuel gas flow field for allowing the fuel gas to flow along the second electrode 46. The second gas flow field 86 includes a plurality of second flow field ridges 88 and a plurality of second flow field grooves 90. The second flow field ridges 88 and the second flow field grooves 90 are alternately provided in the arrow C direction. Each of the second flow field ridges 88 and the second flow field grooves 90 extends linearly in the arrow B direction. Each of the second flow field ridges 88 and the second flow field grooves 90 may extend in a wave form in the arrow B direction.

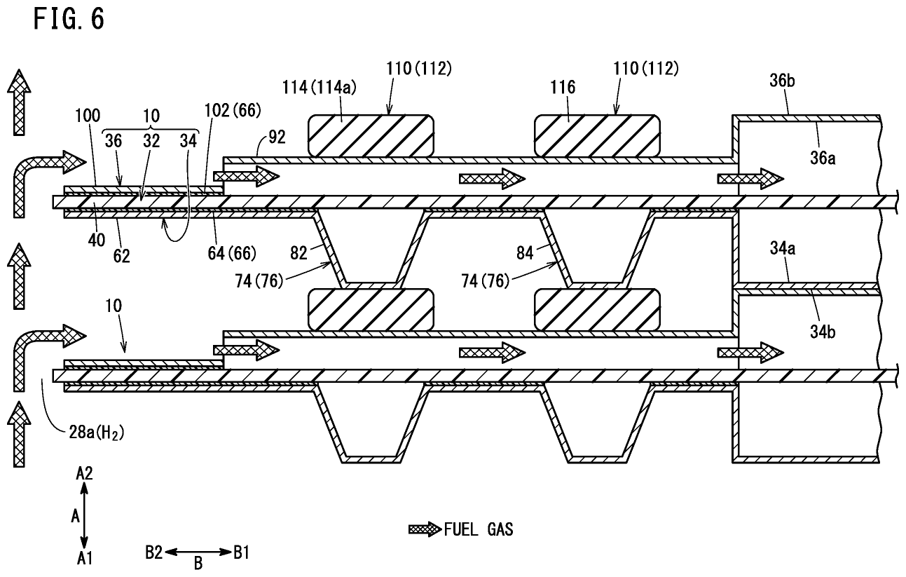

As shown in FIG. 2, the second gas flow field 86 is connected to the fuel gas supply passage 28a through a plurality of second supply tunnels (tunnels) 92. The plurality of second supply tunnels 92 are arranged at intervals in the arrow C direction. The second supply tunnels 92 extend in the arrow B direction. The second supply tunnels 92 bulge from the second front surface 36a toward the second back surface 36b of the second metal separator 36 (in the direction indicated by the arrow A2) (see FIG. 6). The fuel gas can flow through the second supply tunnels 92.

The second gas flow field 86 is connected to the fuel gas discharge passage 28b through a plurality of second discharge tunnels (tunnels) 94. The plurality of second discharge tunnels 94 are arranged at intervals in the arrow C direction. The second discharge tunnels 94 extend in the arrow B direction. The second discharge tunnels 94 bulge from the second front surface 36a toward the second back surface 36b of the second metal separator 36. The fuel gas can flow through the second discharge tunnels 94.

An inlet buffer 96 is provided between the second supply tunnels 92 and the second gas flow field 86. An outlet buffer 98 is provided between the second discharge tunnels 94 and the second gas flow field 86.

As shown in FIG. 3, the second metal separator 36 has a second joining section 100 to which the resin frame member 40 is joined. The resin frame member 40 is joined to the second joining section 100 via a second adhesive layer 102. The second adhesive layer 102 is formed of the same adhesive 66 as that of the first adhesive layer 64 described above.

The second adhesive layer 102 is formed, for example, by applying the adhesive 66 in the liquid form to the second front surface 36a of the second metal separator 36. The second adhesive layer 102 may be formed by applying the adhesive 66 in the liquid form to the other surface (surface facing the second metal separator 36) of the resin frame member 40. The second adhesive layer 102 may be formed by sandwiching an adhesive sheet of a predetermined shape made of the adhesive 66 between the second metal separator 36 and the resin frame member 40.

As shown in FIG. 2, the second adhesive layer 102 surrounds the oxygen-containing gas supply passage 26a, the oxygen-containing gas discharge passage 26b, the fuel gas supply passage 28a, the fuel gas discharge passage 28b, the coolant supply passage 30a, and the coolant discharge passage 30b, individually. The second adhesive layer 102 surrounds the second gas flow field 86.

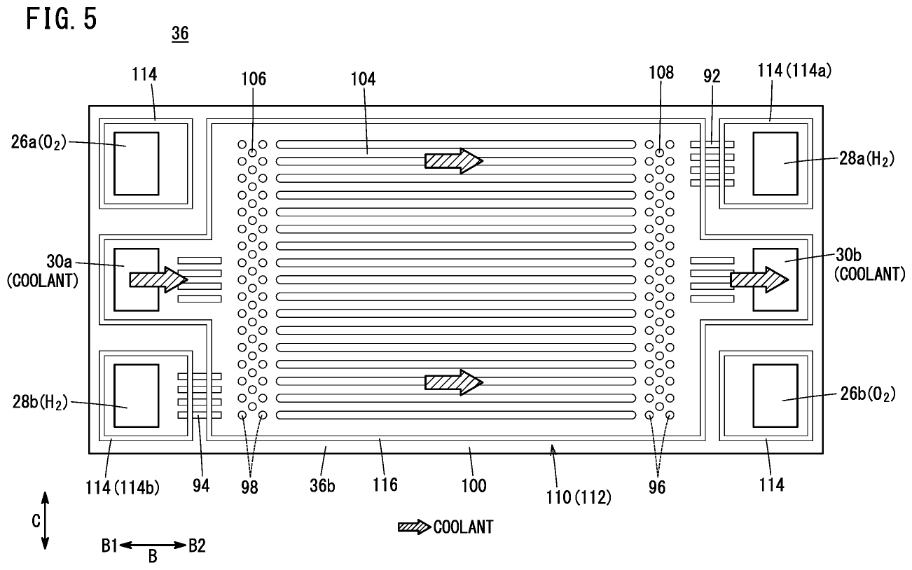

As shown in FIG. 5, a second coolant flow field 104 is formed on the second back surface 36b of the second metal separator 36. The second coolant flow field 104 has a shape of a back surface of the second gas flow field 86. An inlet buffer 106 is provided between the second coolant flow field 104 and the coolant supply passage 30a. An outlet buffer 108 is provided between the second coolant flow field 104 and the coolant discharge passage 30b.

The second metal separator is provided with a second sealing portion (seal) 110 for preventing leakage of the fluid that is the oxygen-containing gas, the fuel gas, or the coolant, to the outside. The second sealing portion 110 extends in a shape like a line. As shown in FIG. 3, the second sealing portion 110 includes an elastically deformable resin seal member 112 attached to the second back surface 36b of the second metal separator 36. The resin seal member 112 is attached to the second joining section 100 of the second metal separator 36.

The resin seal member 112 is made of a rubber material. Specifically, the resin seal member 112 is made of a material such as an EPDM (ethylene propylene diene monomer), an NBR (nitrile butadiene rubber), a silicone rubber, a fluorosilicone rubber, a butyl rubber, a natural rubber, a styrene rubber, a chloroprene rubber, an acrylic rubber, and the like. The resin seal member 112 has a rectangular cross section.

The second sealing portion 110 includes a plurality of second passage sealing portions (passage seals) 114 and a second flow path sealing portion (flow path seal) 116. The plurality of second passage sealing portions 114 individually surround the oxygen-containing gas supply passage 26a, the oxygen-containing gas discharge passage 26b, the fuel gas supply passage 28a, and the fuel gas discharge passage 28b. The second flow path sealing portion 116 surrounds the coolant supply passage 30a, the second coolant flow field 104, and the coolant discharge passage 30b.

Hereinafter, the second passage sealing portion 114 surrounding the fuel gas supply passage 28a may be referred to as a “second passage sealing portion 114a”, and the second passage sealing portion 114 surrounding the fuel gas discharge passage 28b may be referred to as a “second passage sealing portion 114b”.

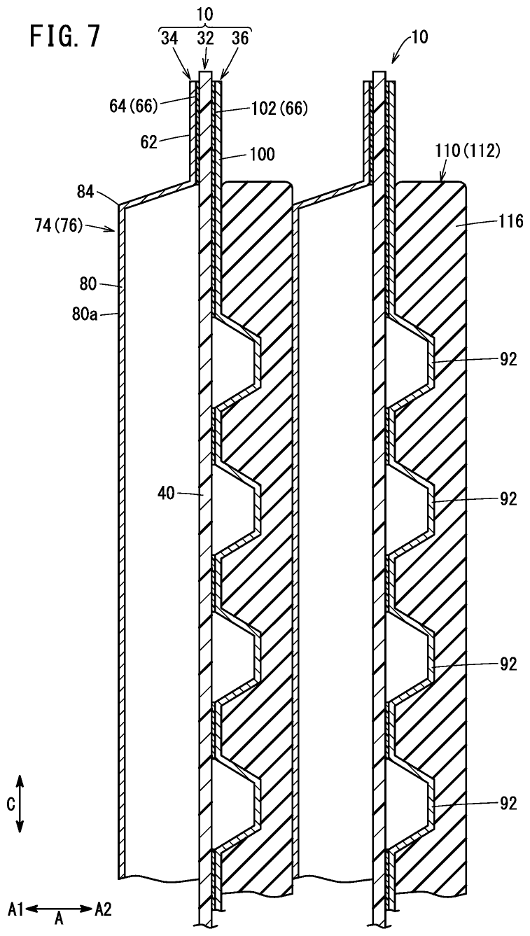

As shown in FIGS. 5 to 7, the second passage sealing portion 114a and the second flow path sealing portion 116 extend over the plurality of second supply tunnels 92 in the direction (the arrow C direction) intersecting the extending direction of the second supply tunnels 92. The second passage sealing portion 114a and the second flow path sealing portion 116 are in contact with the outside surfaces of the second supply tunnels 92. Further, as shown in FIG. 5, the second passage sealing portion 114b and the second flow path sealing portion 116 extend over the plurality of second discharge tunnels 94 in the direction (the arrow C direction) intersecting the extending direction of the second discharge tunnels 94. The second passage sealing portion 114b and the second flow path sealing portion 116 are in contact with the outer surfaces of the second discharge tunnels 94. Further, as shown in FIG. 7, the second sealing portion 110 (resin seal member 112) enters the recess between the second supply tunnels 92 adjacent to each other. In other words, the second sealing portion 110 (resin seal member 112) fills the gap between the second supply tunnels 92 adjacent to each other. Further, the second sealing portion 110 (resin seal member 112) enters the recess between the second discharge tunnels 94 adjacent to each other. In other words, the second sealing portion 110 (resin seal member 112) fills the gap between the second discharge tunnels 94 adjacent to each other.

By the way, if the second sealing portion 110 is formed, for example, as the metal sealing portion 76 described above, the inside of the second sealing portion 110 communicates with the insides of the second supply tunnels 92 and the insides of the second discharge tunnels 94. In this case, a part of the fuel gas supplied from the fuel gas supply passage 28a to the second supply tunnels 92 flows into the fuel gas discharge passage 28b through the inside of the second flow path sealing portion 116 and the insides of the second discharging tunnels 94. That is, the part of the fuel gas bypasses the second gas flow field 86, and therefore the fuel gas cannot be efficiently introduced into the second gas flow field 86.

On the other hand, as shown in FIG. 7, when the second sealing portion 110 is the resin seal member 112, the fuel gas cannot flow through the inside of the second sealing portion 110, and thus the fuel gas can be prevented from bypassing the second gas flow field 86. Thus, the fuel gas can be efficiently guided to the second gas flow field 86. In the first metal separator 34, the first sealing portion 74 is the metal sealing portion 76, and thus the inside of the first sealing portion 74 communicates with the insides of the first supply tunnels 54 and the insides of the first discharge tunnels 56. In this case, a portion of the oxygen-containing gas supplied from the oxygen-containing gas supply passage 26a to the first supply tunnels 54 flows through the inside of the first sealing portion 74 and the insides of the first discharging tunnels 56 to the oxygen-containing gas discharge passage 26b. That is, a part of the oxygen-containing gas bypasses the first gas flow field 48. However, since the fluid bypassing the first gas flow field 48 is not the fuel gas but the oxygen-containing gas, the impact on the power generation efficiency is small.

As shown in FIGS. 3, 6 and 7, the resin seal member 112 is in contact with the metal sealing portion 76 in a state where the plurality of power generation cells 10 are stacked on each other. Hereinafter, the plurality of power generation cells 10 in a state in which the power generation cells are stacked one another will be referred to as “the power generation cells 10 as stacked”. A predetermined tightening load is applied to the power generation cells 10 as stacked.

The resin seal member 112 is in contact with the top end surface 80a of the metal sealing portion 76 in the power generation cells 10 as stacked. In this state, each of the metal sealing portion 76 and the resin seal member 112 is elastically deformed. That is, an appropriate sealing surface pressure acts on the metal sealing portion 76 and the resin seal member 112. This can prevent the fluid from leaking from a boundary between the first metal separator 34 and the second metal separator 36. The top end surface 80a of the metal sealing portion 76 is flat in the power generation cells 10 as stacked. In the embodiment shown in FIGS. 3 and 6, the second metal separator 36 is flat and does not protrude like the metal sealing portion 76 at a portion in contact with the resin seal member 112. That is, the second metal separator 36 is flat, without protrusion like the metal sealing portion 76, at a portion facing the metal sealing portion 76 in the stacking direction.

As shown in FIG. 3, the widthwise size W1 of the resin seal member 112 is larger than the widthwise size W2 of the top end surface 80a of the metal sealing portion 76 in the power generation cells 10 as stacked. The widthwise size W1 is a size of the resin seal member 112 in a direction (second direction) intersecting with the extending direction (first direction) of the resin seal member 112 and the stacking direction of the power generation cells 10. The widthwise size W2 of the top end surface 80a of the metal sealing portion 76 is a size of the top end surface 80a of the metal sealing portion 76 in the direction (second direction) intersecting with the extending direction (first direction) of the metal sealing portion 76 and the stacking direction of the power generation cells 10. The widthwise size W1 of the resin seal member 112 is larger than the widthwise size W3 of the base end portion of the metal sealing portion 76 in the direction (second direction) intersecting with the extending direction (first direction) of the metal sealing portion 76 and the stacking direction of the power generation cells 10.

The widthwise size W1 may be equal to or smaller than the widthwise size W3. In this case, the widthwise size W1 may be larger than the widthwise size W2, or may be equal to or smaller than the widthwise size W2.

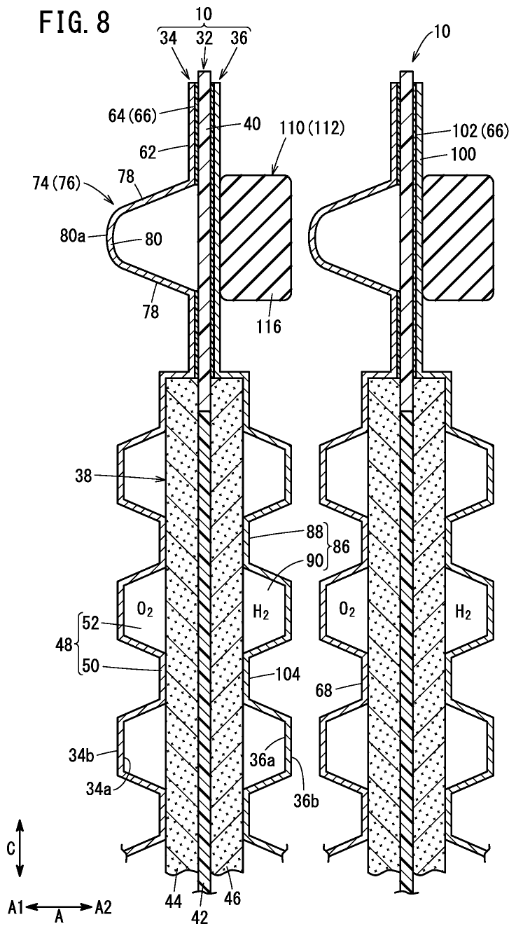

As shown in FIG. 8, the fuel cell stack 12 is formed by manufacturing a plurality of power generation cells 10, stacking the manufactured power generation cells 10 one another, and then applying a tightening load to the power generation cells 10 as stacked by a pair of end plates 20a, 20b (see FIG. 1). In the power generation cells 10 before being stacked one another, the top end surface 80a of the metal sealing portion 76 is curved in a convex shape in the protruding direction of the metal sealing portion 76. The metal sealing portion 76 is elastically deformed when the tightening load is applied to the power generation cells 10, whereby the top end surface 80a of the metal sealing portion 76 becomes flat (see FIG. 3).

The fuel cell stack 12 according to the present embodiment operates as follows.

First, as shown in FIGS. 1 and 2, the oxygen-containing gas is supplied to the oxygen-containing gas supply passage 26a. The fuel gas is supplied to the fuel gas supply passage 28a. The coolant is supplied to the coolant supply passage 30a.

The oxygen-containing gas flows from the oxygen-containing gas supply passage 26a into the first gas flow field 48 through the first supply tunnels 54. The oxygen-containing gas flows through the first gas flow field 48 in the direction indicated by the arrow B2, and is supplied to the first electrode 44 of the membrane electrode assembly 38.

The fuel gas flows from the fuel gas supply passage 28a into the second gas flow field 86 through the second supply tunnels 92. The fuel gas flows through the second gas flow field 86 in the direction indicated by the arrow B1, and is supplied to the second electrode 46 of the membrane electrode assembly 38.

In the membrane electrode assembly 38, the oxygen-containing gas supplied to the first electrode 44 and the fuel gas supplied to the second electrode 46 are consumed in the first electrode catalyst layer and the second electrode catalyst layer by electrochemical reactions. As a result, power generation is performed.

Then, a remainder of the oxygen-containing gas after having been supplied to and consumed at the first electrode 44 is discharged as the oxygen-containing off gas from the first gas flow field 48 to the oxygen-containing gas discharge passage 26b through the first discharge tunnels 56. A remainder of the fuel gas after having been supplied to and consumed at the second electrode 46 is discharged as a fuel off gas from the second gas flow field 86 to the fuel gas discharge passage 28b through the second discharge tunnels 94.

The coolant supplied to the coolant supply passage 30a flows into the first coolant flow field 68 and the second coolant flow field 104 formed between the first and second metal separators 34, 36. The coolant flows in the arrow B2 direction after being introduced into the first coolant flow field 68 and the second coolant flow field 104. After the coolant cools the membrane electrode assembly 38, the coolant is discharged from the coolant discharge passage 30b.

According to the present embodiment, even when the metal sealing portion 76 and the resin seal member 112 are about to be displaced from each other in the surface direction of the electrolyte membrane 42, the resin seal member 112 can be easily elastically deformed in the surface direction, and thus the contact state between the metal sealing portion 76 and the resin seal member 112 can be maintained. Therefore, the leakage of the fluid from a boundary between the first metal separator 34 and the second metal separator 36 can be effectively prevented. Further, since the first sealing portion 74 is the metal sealing portion 76, the amount of the resin seal member 112 used can be reduced as compared with the case where both the first sealing portion 74 and the second sealing portion 110 are formed of the resin seal member 112. This can reduce the material cost.

### Modification

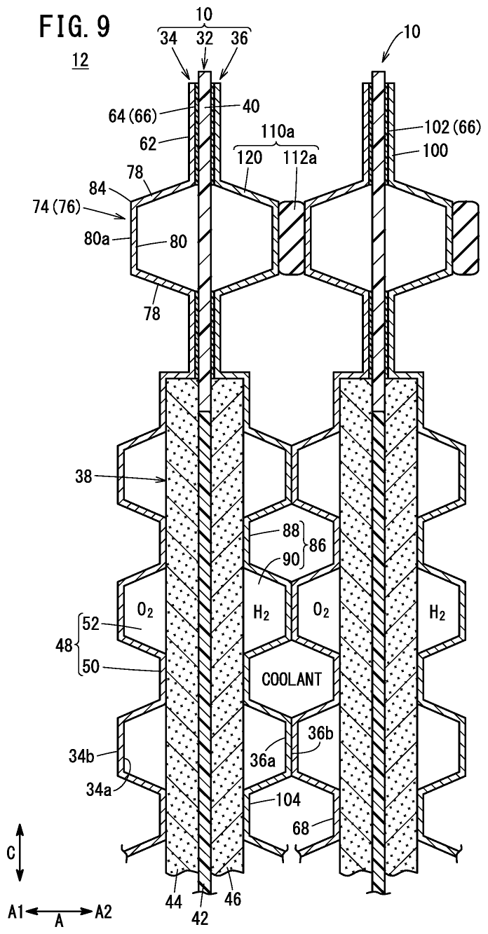

The second metal separator 36 of the power generation cell 10 may have a second sealing portion 110a according to a modification shown in FIG. 9 instead of the second sealing portion 110. In the present modification, constituent elements that are identical to those of the fuel cell stack 12 described above are labeled with the same reference numerals, and detailed description thereof is omitted.

As shown in FIG. 9, the second sealing portion 110a includes a metal sealing portion 120 and a resin seal member 112a. The metal sealing portion 120 is configured similarly to the metal sealing portion 76 of the first sealing portion 74. The resin seal member 112a is attached to the top end surface of the metal sealing portion 120. The resin seal member 112a is configured similarly to the resin seal member 112 described above. In this case, the resin seal member 112a of the second sealing portion 110a is in contact with the top end surface 80a of the metal sealing portion 76 of the first sealing portion 74 in the power generation cells 10 as stacked.

In this modification, the resin seal member 112a may be attached to the top end surface 80a of the metal sealing portion 76 of the first sealing portion 74, instead of the top end surface of the metal sealing portion 120.

In addition to the above disclosure, the following appendices are further disclosed.

### Appendix 1

The power generation cell (10) includes the membrane electrode assembly (38) having the electrolyte membrane (42), and the cathode (44) and the anode (46) disposed on both sides of the electrolyte membrane, and the first metal separator (34) and the second metal separator (36) disposed on both sides of the membrane electrode assembly, each of the first metal separator and the second metal separator including the flow field through which a fluid flows, the fluid being one of the oxygen-containing gas, the fuel gas the coolant, wherein each of the first metal separator and the second metal separator includes the sealing portion (74, 110, 110a) for preventing leakage of the fluid between the first metal separator and the second metal separator in the case where the power generation cell is provided in plural and the plurality of power generation cells are stacked one another in a manner that the first metal separator and the second metal separator are positioned adjacent to each other, the sealing portion of the first metal separator is the elastically deformable metal sealing portion (76) protruding from the first metal separator in a direction away from the membrane electrode assembly, the sealing portion of the second metal separator is the elastically deformable resin seal member (112, 112a) attached to the surface (36b) of the second metal separator opposite to the surface facing the membrane electrode assembly, and the resin seal member is in contact with the metal sealing portion in a state where the plurality of power generation cells are stacked one another.

With the arrangement described above, even when the metal sealing portion and the resin seal member are about to be displaced from each other in the surface direction of the electrolyte membrane, the resin seal member can be easily elastically deformed in the surface direction, and thus the contact state between the metal sealing portion and the resin seal member can be maintained. Therefore, the leakage of the fluid from a boundary between the first metal separator and the second metal separator can be effectively prevented. Further, since the sealing portion of the first metal separator is the metal sealing portion, the amount of the resin seal member used can be reduced as compared with the case where all the sealing portions are formed by the resin seal members. This can reduce the material cost.

### Appendix 2

The power generation cell according to Appendix 1 may further includes the resin frame (40) extending to surround the outer periphery of the membrane electrode assembly, wherein the second metal separator may have the joining section (100) to which the resin frame is joined, and the resin seal member may be attached to the joining section.

With the arrangement described above, since the metal sealing portion is not formed in the second metal separator, the configuration of the second metal separator can be simplified.

### Appendix 3

In the power generation cell according to Appendix 2, the flow field of the second separator may include the fuel gas passage (28a, 28b) through which the fuel gas flows in the stacking direction when the plurality of power generation cells are stacked one another, the fuel gas flow field (86) through which the fuel gas flows along the anode, and the tunnel (92, 94) for allowing the fuel gas passage and the fuel gas flow field to communicate with each other, and the resin seal member includes a passage sealing portion (114) surrounding the fuel gas passage and a flow path sealing portion (116) surrounding the fuel gas flow field, and the passage sealing portion and the flow path sealing portion are in contact with the outside surface of the tunnel.

With the arrangement described above, since the resin seal member includes the passage sealing portion and the flow path sealing portion, the fuel gas flowing through the tunnel will not partially flow into the inside of the passage sealing portion and the inside of the flow path sealing portion. Thus, the fuel gas is prevented from bypassing the fuel gas flow field. That is, the fuel gas can be efficiently supplied to the fuel gas flow field. In this manner, it is possible to improve fuel efficiency of the power generation cell.

### Appendix 4

In the power generation cell according to any one of Appendices 1 to 3, the sealing portion may extend in a form of a line in the first direction along the surface direction of the electrolyte membrane, and in the second direction intersecting the stacking direction when the plurality of power generation cells are stacked and the first direction, the widthwise size (W1) of the resin seal member may be larger than the widthwise size (W2) of the top end surface (80a) of the metal sealing portion.

With the arrangement described above, even when the resin seal member and the metal sealing portion are about to be displaced in the surface direction of the electrolyte membrane, the contact state between the resin seal member and the metal sealing portion is easily maintained. This makes it possible to seal between the resin seal member and the metal sealing portion suitably.

### Appendix 5

In the power generation cell according to any one of Appendices 1 to 4, the top end surface of the metal sealing portion may be curved convexly in a protruding direction of the metal sealing portion in the power generation cell before being stacked.

With the arrangement described above, the surface pressure acting on the sealing portion when the plurality of power generation cells are stacked can be increased as compared with the case where the top end surface of the metal sealing portion is formed flat in the power generation cell before being stacked. In this way, when the plurality of power generation cells are stacked, the metal sealing portion and the resin seal member are less likely to be displaced from each other in the surface direction of the electrolyte membrane. Further, as compared with the case where the top end surface of the metal sealing portion is formed flat before the power generation cells are stacked, the reaction force acting on the sealing portion when the tightening load is applied to the plurality of power generation cells can be reduced. In this manner, the rigidity of the components (end plates or casing) that receive the reaction force acting on the sealing portion need not be set to be higher than necessary, and therefore the weight of the fuel cell stack can be reduced. This makes it possible to reduce the manufacturing cost of the fuel cell stack.

### Appendix 6

In the power generation cell according to Appendix 1, the sealing portion of the second metal separator may include another metal sealing portion (120) that is elastically deformable and protrudes from the second metal separator in a direction away from the membrane electrode assembly, and the resin seal member may be attached to a top end surface of the other metal sealing portion.

According to such a configuration, the amount of the resin seal member used can be further reduced.

### Appendix 7

The fuel cell stack (12) may include the power generation cell according to any one of Appendices 1 to 6, wherein the power generation cell is provided in plural and the plurality of the power generation cells are stacked one another.

The present invention is not limited to the above disclosure, and various modifications are possible without departing from the essence and gist of the present invention.

1. A power generation cell comprising:
a membrane electrode assembly including an electrolyte membrane, and a cathode and an anode disposed on both sides of the electrolyte membrane, and
a first metal separator and a second metal separator disposed on both sides of the membrane electrode assembly, wherein
each of the first metal separator and the second metal separator includes a flow path through which a fluid flows, the fluid being one of an oxygen-containing gas, a fuel gas and a coolant,
each of the first metal separator and the second metal separator includes a sealing portion for preventing leakage of the fluid from a boundary between the first metal separator and the second metal separator in a case where the power generation cell is provided in plural and the plurality of power generation cells are stacked one another in a manner that the first metal separator and the second metal separator are positioned adjacent to each other,
the sealing portion of the first metal separator is an elastically deformable metal sealing portion protruding from the first metal separator in a direction away from the membrane electrode assembly,
the sealing portion of the second metal separator is an elastically deformable resin seal member attached to a surface of the second metal separator that is opposite to a surface facing the membrane electrode assembly, and
the resin seal member is in contact with the metal sealing portion in a state where the plurality of power generation cells are stacked one another.

2. The power generation cell according to claim 1, further comprising:
a resin frame extending to surround an outer periphery of the membrane electrode assembly, wherein
the second metal separator includes a joining section to which the resin frame is joined, and
a resin seal member is attached to the joining section.

3. The power generation cell according to claim 2, wherein the flow path of the second separator comprises:
a fuel gas passage through which the fuel gas flows in a stacking direction when the plurality of power generation cells are stacked one another;
a fuel gas flow field through which the fuel gas flows along the anode; and
a tunnel for allowing communication between the fuel gas passage and the fuel gas flow field, and
the resin seal member comprises:
a passage sealing portion surrounding the fuel gas passage; and
a flow path sealing portion surrounding the fuel gas flow field, and
the passage sealing portion and the flow path sealing portion are in contact with an outside surface of the tunnel.

4. The power generation cell according to claim 1, wherein
the sealing portion extends in the first direction along a surface direction of the electrolyte membrane in a form of a line, and
in a second direction intersecting a stacking direction when the plurality of power generation cells are stacked and the first direction, a widthwise size of the resin seal member is larger than a widthwise size of the top end surface of the metal sealing portion.

5. The power generation cell according to claim 1, wherein
the top end surface of the metal sealing portion is curved convexly in a protruding direction of the metal sealing portion in the power generation cell before being stacked.

6. The power generation cell according to claim 1, wherein
the sealing portion of the second metal separator includes another metal sealing portion that is elastically deformable and protrudes from the second metal separator in a direction away from the membrane electrode assembly, and
the resin seal member is attached to a top end surface of the another metal sealing portion.

7. A fuel cell stack comprising the power generation cell according to claim 1, wherein the power generation cell is provided in plural and the plurality of the power generation cells are stacked one another.
